(19) United States
(12) Patent Application Publication
(10) Pub. No.: US 2005/0289061 A1
(43) Pub. Date: Dec. 29, 2005

(54) Secure authentication system for collectable and consumer items

(76) Inventors: Michael Kulakowski, Jackson, NJ (US); Robert Kulakowski, Carlsbad, CA (US)

Correspondence Address: MICHAEL KULAKOWSKI, 5 CARLSON COURT, JACKSON, NJ, 08527, US

(21) Appl. No.: 11/157,282

(22) Filed: Jun. 21, 2005

Related U.S. Application Data
(60) Provisional application No. 60/582,306, filed on Jun. 24, 2004.

(51) Int. Cl. G06Q 99/00

(52) U.S. Cl. 705/50

(57) ABSTRACT

A system and methods to authenticate collectable items using Unique Identifier (FIG. 1 element 110) housed within collectable item (FIG. 1 element 100) or attached to collectable item, Unique Identifier reader (FIG. 5 element 500), and

Authentication Authority database (FIG. 6 element 680). Cryptographic techniques and Authentication Unique data (FIG. 8) increases the authentication strength of collectable item and establish ownership lineage of collectable item.

### BACKGROUND-FIELD OF THE INVENTION

This invention relates to identifying and authenticating collectable items as well as high value consumer goods.

### BACKGROUND-PRIOR ART

Prior Art

U.S. Pat. No. 6,691,916 issued to Noyes disclose a tamper proof labeling system for autograph verification and authentication. This patent uses a signed statement associated with the labels to verify the signature authentication of collectable items.

### OBJECTS AND ADVANTAGES

When applied to a baseball, this invention embeds a Unique ID within a sports item, and the Unique ID becomes intrinsically linked to the “Greatest Moments” in sports. Unique ID readers strategically located within stadiums record the balls disposition throughout the game compiling details pertaining to its speed, distance, height, time, teams, players, and linking that item to video footage and sporting news. Memorabilia collectors will rely on the strong authentication methods provide by this invention to validate collectable items. In this patent application the term collectable item is used and the techniques described also apply to consumer items such as purchases, watches, leather goods, and other consumer goods.

Sport items tracked by this invention are authenticated and validated using public and private key encryption to insure the items association to a given sporting event and guarantee the value of that item. Additional authentication is provided by an Authentication Authority that maintains a database for all collectable items.

The Authentication Authority database contains information establishing a digital record or history of a sporting object, its place in history, the printed and video records of that event, and the valuation and ownership records for that sporting item.

The invention described herein, firstly authenticates a sporting object from its creation to its significant disposition and secondly to establish an irrefutable chain of ownership to that valuable sporting article. The invention described herein provides the same benefits to any valuable collectable items such as: art, musical instruments, china, tapestries, sporting items, racing items, clothing, and other collectable items. This invention also applies to high value consumer items such as purses, designer clothing, perfume, jewelry, sneakers, all types of equipment, and other consumer goods.

Automated registration of game collectables occurs via reader device detecting the collectable placed into a game. Bats, baseballs, hats, gloves, uniforms, etc. are examples of items that can be registered for the game of baseball. Time stamp that is added in Authentication Authority AA database for uniforms, hats, gloves, bats, etc. establish the history of the clothing players wore during a particular game. Unique ID as described in this invention will apply the same authenticity capabilities and history linage tracking to all collectables containing Unique ID chips. Registering the Unique ID with an AA establishes the true linage and ownership of the collectable item. Registration process can occur many times for initially registering the product when manufactured, and then distribution level 1 registration when the item is shipped to a master distributor, distribution level(s) 2 thru N when multiple tiers of distribution are utilized in the distribution chain (including retail store chain distribution), point-of-sale distribution where the item is sold to a consumer, consumer registration when the purchasing consumer registers the item, followed up with optional resale distribution when the original consumer or a subsequent owner of the product registers the product. The Product registration at any of the above points will utilize the unique data within a product as shown in FIG. 1 and FIG. 2.

The term Digital Signature when used in this application includes any and all techniques used to create a unique cryptographic identifier that can be authenticated by the signing party and/or a second or third party. There are many forms of Digital Signatures available including using digital certificates issues by a Certificate Authority such as Verisign. In this application any type of Digital Signature can be applied and this invention anticipates that any form of currently secure Digital Signature or a future Digital Signature technique can be utilized within this invention, and this invention is not tied solely to one type of Digital Signature technique. The same is said of encryption, RFID type, and other elements whereby the best-of-breed technology can be used as building blocks for this invention.

Still using baseball as an example, when the umpire inspects a ball being put into play and throws the ball out to the mound baseball identification will automatically occur. The umpire's ball pocket containing the reserve of baseballs includes an ID reader and detects the ball being removed from the ball reserve pocket. Optionally the umpire can have an ID reader on his throwing arm wrist and the ID reader detects the baseball ID. After reading the baseball ID from the ball being placed into play, the ID reader will record the baseball ID, and optionally the date and time of when the ball is placed into service into database. Transfer of baseball ID and optional date and time can be stored in reader or sent using wired or wireless communications means to database.

Similar ID reader and recorder can be embedded into baseball gloves, ID reader type watches worn by ball balls, players, base coaches, catchers and other team or support personnel.

### DESCRIPTION OF DRAWINGS

FIG. 1 shows an example of a Unique ID 110 contained within collectable item 100.

FIG. 2 shows a Unique ID Chip 200 and the elements that comprise the unique ID Chip 200.

FIG. 3 shows an umpire 320 wearing one or more Unique ID readers 310, 311, and pouch for holding baseballs 330 and baseballs (representing collectable items 100).

FIG. 4 shows a body worn or standalone RFID reader.

FIG. 5 shows a Unique ID reader (called Trusted Reader) 500 and the elements that comprise the trusted reader.

FIG. 6 shows a store reader 601 and its elements, along with a network connection 665 to Authentication Authority 670 and link to validate authentication of an item to collector 605 via cellular telephone 607.

FIG. 7 shows link between collectable item 100 and event video 760 filmed using camera 740 with unique ID being added to video 761 and remote database 790.

FIG. 8 shows Authentication Unique Data 800, individual data (items 810, 820, 830, and 840).

Below FIG. 8 is FIG. 9 that shows the steps used to authenticate an item (FIG. 9 Steps 1, 2, and 3).

FIG. 10 shows cryptographic calculation example using two variables 905 and 840 and cryptographic function 910 with output results 920.

FIG. 11 shows an actual baseball representing Collectable Item 100 and the internal to the baseball Unique ID exposed 110.

FIGS. 12A through 12J shows database information.

FIG. 13 shows a system overview for baseball.

FIG. 14 shows an example of the placement of multiple Unique ID readers for baseball stadiums.

### DETAILED DESCRIPTION

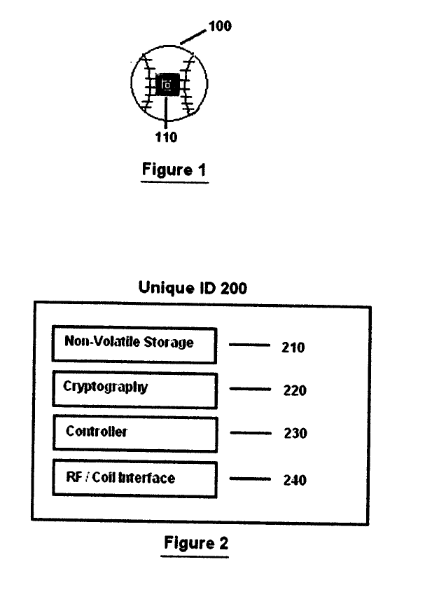

In FIG. 1 a collectable item 100 in the form of a baseball is shown with a Unique ID 110 device. Unique ID 110 is used to store a code that is unique to the collectable item 100. The object of FIG. 1 is a baseball 100, but this item can be any collectable or consumer (non-collectable) item such as a pair of designer jeans, purse, sneakers, musical instrument, eyeglasses, or any other item sold in a store, at an online auction, over the internet, or any other item sold, traded, or bartered in any form of commerce. In this invention the Authentication Authority (AA) refers to the authority that is established to verify that an article is authentic, or to track an items sales, manufacturing, distribution history, even the resale history of an item. Sometimes an Authentication Authority (AA) is also referred to as a Certificate Authority (CA). An example of an AA for a baseball can be Major League Baseball, a company such as Verisign, a bank or credit card company, baseball manufacturer, or a baseball trading card company.

Unique ID 110 contains collectable item 100 specific information including but not limited to any one or more of the following:
1. serial number,
2. serial number plus digital signature of serial number. Digital signature is generated using private key of the official authenticator for collectable, or the manufacturer of the product or some other trusted authority, and/or a serial number plus other unique data
3. serial number plus other data used in cryptographic functions including optional Digital Signature and other data
4. serial number plus crypto unit plus digital signature serial number hash
5. other cryptographic method(s) or other cryptographic data that can be used to identify an item or serial number as unique

In this invention the term RFID is used to represent one method of storing a Unique ID within a collectable object. Other methods of storing and reading a Unique ID from a collectable item can be substituted for an actual RFID chip. All of the different methods and chips that can be used to store a Unique ID are collectively referred to as RFID in this patent application. So the use of a chip different from an RFID is anticipated by this invention.

Serial number can be one-time programmable into Unique ID memory whereby once the serial number is programmed into the RFID chip the serial number cannot be modified at a later date. Serial number can be programmed via laser programming during chip manufacturing. Other methods of programming the serial number that guarantee that the chips serial number cannot be reprogrammed can be used for guaranteeing that the serial number is unique and cannot be copied by dubious individuals. A programming fuse that can be used to write the serial number and other information into the chip and then the programming fuse is blown to eliminate the potential of serial number and other data from being rewritten. Other areas of the memory can still be read and written to for storage of data that is not used in the authentication of an item.

Unique ID can be programmed into RFID during RFID chip manufacturing, or after final assembly of collectable item. Preferred embodiment is programming Unique ID during chip manufacturing. Regardless of where Unique ID is programmed into chip, Unique ID can be made unchangeable by burning programming fuse, eliminating the potential to reprogram the Unique ID and other write-once areas of the chip.

As will be explained below the Unique ID 110 can include cryptographic processing elements to improve the ability to uniquely identify a collectable 100. Examples of the various cryptographic techniques that can be used to identify an item as unique include: Public/Private Key Encryption, RSA or Digital Signature Algorithm, one-way hash algorithms (cryptographic and numeric), symmetric key algorithms, and other security algorithms.

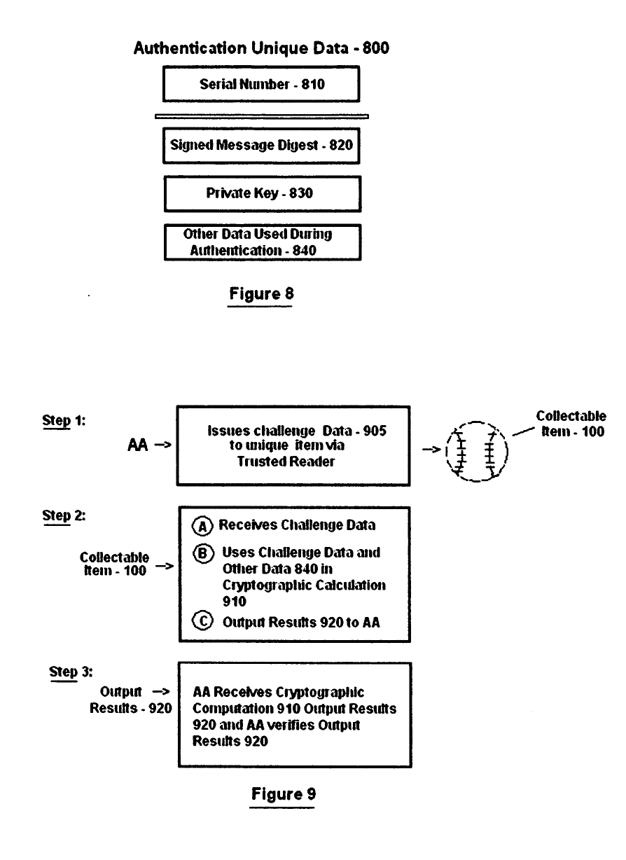

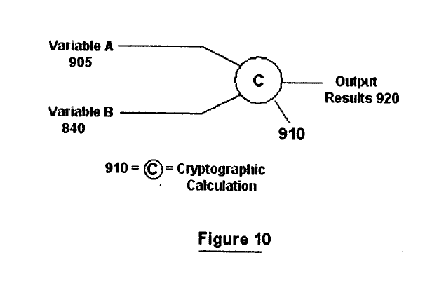

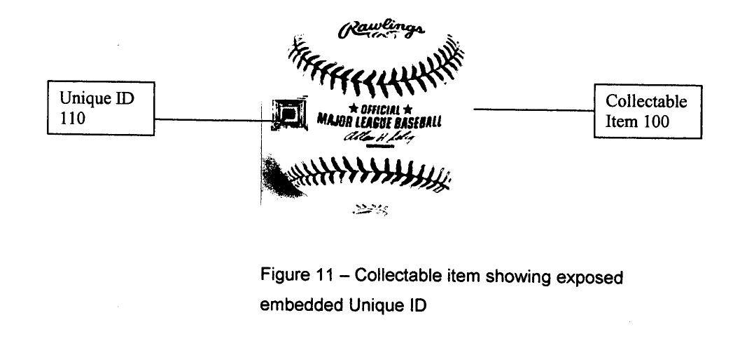

The term authentication strength is used in this invention and describes the means that can be used to increase the validity of a collectable item. Prior art in authenticating collectable items include using a standard RFID with only a serial number. This has average authentication strength. Average strength protection means that it would take a devious person some work to copy the serial number of the RFID. But since the RFID serial number can easily be read from a collectable device, the devious person programming the same RFID serial number into a non-authentic RFID can make a duplicate of the collectable item. By using addition cryptographic techniques with added authentication data stored in the device itself and never transferring the added authentication data out of the device the authentication strength is increased. The added authentication data stored in the device is used for internal calculations only and is never transferred out of the device. Collection Authority will know the values of the added authentication data values used to increase the authentication strength and will verify that the calculations performed with the added authentication data stored in the collectable item match the expected values computed by the Collection Authority during authentication of an item. Since only the AA knows the values of the added authentication data, and they are used only in cryptographic functions and never output from the chip it is very difficult for counterfeiters to compute the values of added authentication data used to increase the assurance provided by a CA that an item is authentic. Added authentication data is shown in FIG. 8 and discussed in more detail below. This invention also includes increasing authentication strength by recording information using different forensic techniques such as X-RAY scans of the item with embedded RFID device for very high value collectables such as rare china or famous artwork or jewelry. Forensic technique data such as an X-RAY scan is added to database of Authentication Authority.

Because the Authentication Authority database contains information that can be updated by an individual with a collectable item the M database can be used to eliminate the value of stolen items. Having the AA authenticate the first registered owner of a high value object does this. Subsequent owners of high-value objects are identified in the AA database and if an object is stolen the person in possession after the item is stolen will not show up on the AA database as the owner of record. Any persons interested in purchasing the high-value object can check the AA database and determine the item was stolen in the past.

Registered owners name or identification (name, address, collector ID, etc.) can be stored in Non-Volatile Storage within chip. A digitally signed version of Registered owners name or identification (name, address, collector ID, etc.) can be stored in Non-Volatile Storage within chip allowing the storage area to be verified using public key of AA. Other means to cryptographically secure the registered owners name and other information stored in Non-Volatile Storage within chip can be applied to data being stored.

Chip can optionally use cryptographic techniques to verify that only the AA can store data within Non-Volatile Storage. When a write to Non-Volatile Storage is requested by a store or trusted reader, the chip can verify information provided by AA before storing data to memory.

In the prior art only RFID serial numbers were read and this invention improves upon simply reading serial numbers by including added data used in cryptographic calculations along with authentication challenges issued by an Authentication Authority.

In FIG. 1 a baseball was used to represent a collectable item 100, however, collectable item 100 can be any type of collectable item such as: art, glass items, watches, jewelry, sports memorabilia, dishes, musical instruments, crystal, dresses, game and/or game related items, toys, dolls, action figures, antiques, photographs, books, magazines, signs, horse racing equipment and clothing, boxing gloves, auto racing clothing and gear, racing tires, inside the handle of bats, players shoes, baseball collectable cards, etc.

Existing collectables that do not have the benefits provided by this invention can be retrofitted after authentication by an authentication expert. For example, a famous musical instrument can be authenticated as original, and the authentication expert can secure an RFID tag into or onto the instrument and then the authentication expert will register the collectable item in a database along with the current owner of the instrument.

The RFID tag placement and adhesion to the object will be permanent, tamper proof, and revealing of efforts to remove said tag. RFID tag placement may also utilize xray, “catscan”, or MRI technology to validate an RFID tag's placement coordinates.

Registering existing collectables with ownership lineage strengthens the collectable value of an item by being able to link the ownership of an item with the RFID of an item. If the items RFID is not being sold by the owner of record stored in the Authentication Authorities database then the buyer can determine that additional research on the items background must be performed. The perspective buyer of an item will know the authentic items unique ID and will check the Authentication Authorities database to verify the owner. Even if the unique ID of an original item is stolen and attached to a bogus replica, the ownership lineage of the bogus item will not match that of the Authentication Authorities database. Because of being able to register with an Authentication Authority both an authenticated items ID (and other information about the item) and the current registered owner of the item, the value of collectable items is enhanced because of the ability to detect bogus items and non-registered owners (owner of record with the Authentication Authority) trying to sell bogus items.

A block diagram of the Unique ID element 110 of collectable 100 is shown in FIG. 2.

Non-Volatile Storage 210

The collectable identification information of this invention includes non-volatile storage (NV-Storage) 210. NV-Storage 210 stores at a minimum the items unique identification that will be used to verify authenticity of item.

A preferred embodiment of the invention stores the items unique identification plus added information for added authentication in NV Storage 210. Added authentication information stored in NV Storage 210 increases the authentication strength of the invention. Example of added information can include a private key stored in NV Storage 210 that is used to sign or encrypt unique ID information or additional data used during authentication challenge handshakes with AA. Additional encryption key(s), or an additional data value(s) that are used for signing, hashing, or in authentication challenges can be stored in NV Storage 210.

Embedded key(s) store in NV Storage 210 can be an item specific number digitally signed by using the private key of the Authentication Authority (item private key) for the particular item being protected that increases the protection because the item private key signed data is never read out of the item. The items private key signed data or private key data can be used when hashing an interrogation request when authentication an item. Storage of addition private or public key data, or additional ID data not exposed during Unique ID readout increases authentication strength when authenticity of item is being validated. Added information in NV-Storage 210 beyond just a unique ID increases authentication strength. Any cryptographic means for challenge handshake authentication can be utilized between the AA and the RFID.

AA can store unique encryption key in NV-Storage in additional to unique serial numbers for each item thereby eliminating the potential that a single key being compromised will compromise the entire validity of authentication. AA can store separate and different encryption keys and digital signature keys in Non-Volatile Storage 210. AA can store unique values by AA in NV-Storage 210 that are used during item authentication.

AA can store unique values signed by AA in NV-Storage 210 that are used during item authentication.

NV-Storage 210 can also be used to store historic information about the collectable inside the collectable such as the date and time a specific home run or hit was made, the ball park location of the historic event and other historic information. This information will be stored in a read-write portion of the NV-Storage 210 whereas the collectable items unique ID will only be stored in a read-only portion of the NV-Storage eliminating the possibility that a unique ID can be changed. Unique ID can be store in a write once, read many times portion of the device. Depending on NV-Storage size video of the historic event, or a picture of the event, artist, or other information pertaining to the collectable can be stored in NV-Storage 210 of collectable device. Video of a still picture image of the person (fan or spectator) catching or acquiring the collectable item can be stored in the read-write portion of the item.

Crypto unit 220 shown in FIG. 2 provides cryptographic support allowing the Unique ID 200 to perform cryptographic calculations, hashes, transforms, etc. when displaying or authenticating the device. The crypto unit 220 is not required in all embodiments of this invention.

Controller 230 in Unique ID 200 is used to control the read access of the Non-Volatile Storage 210. Controller 230 also provides access to crypto unit 220 if included in Unique ID hardware 200.

In the example shown in FIG. 2 the Unique ID interface for reading and writing the Non-Volatile Storage 210 is based on an RF/Coil Interface 240 similar to, or identical to industry standard RFIDs. Other means of non-contact information exchange can be used in place of the RF/Coil Interface 240 without changing the functionality of the invention.

FIG. 8 shows a diagram of different data values that can be used as Authentication Unique Data to generate the Unique ID including a Serial Number 810 plus optional additional data (820, 830, 840) that is stored in a preferred embodiment of the invention. A serial number 820 alone can be used in a minimal version of this invention and still enjoy benefits beyond the prior art. The serial number 810 alone can be provided when the Unique ID 110 of collectable item 100 is queried. However, the preferred embodiment increases the authentication strength of the invention and examples of additional data values beyond serial number 810 that can be used and how the usage will strengthen authentication will be described below. Other methods to increase authentication strength can be used and are not limited to only the methods discussed below.

In FIG. 8 the Signed Message Digest 820 value is an optional value that is used to strengthen authentication. The Signed Message Digest 820 is a value that is not read out of the chip during authentication. Rather it can be used in cryptographic functions to provide device specific information that is not available by reading the memory contents from the RF link. An example of the Signed Message Digest 820 is a 128 to 2048bit data value that uses the Serial Number 810 and generates a hash on this value using the private key of the Authentication Authority or some other trusted authority. The Signed Message Digest can be used during authentication as a seed or data value used in cryptographic functions.

The Private Key 830 can be used in the same manner as a private key in public/private key cryptography for use as a key for PKI functions, or as inputs for digitally signing information input to the chip during authentication, or for digitally signing information output from the chip during authentication. Private key will be stored during the programming of the NV-Storage (210 FIG. 2). Also shown in FIG. 8 is Other Data 840 that represents different data that can be used to increase the authentication strength of collectable item.

The important feature of the data in FIG. 8 is that it shows the minimum data value that needs to be stored in the collectable item, that being the serial number 810 and also additional data that increases the authentication strength beyond serial number only authentication. Data that increases the authentication strength such as elements 820, 830, and 840 should not be read out of the chip making the copying of Unique ID and other data used only inside the chip and not output to the public much more difficult. And, with registration with an Authentication Authority the lineage of a collectable item is protected from a devious person from posing as a collector with an authentic item. This is because the CA's database for the item most likely will contain the real owner of the real collectable item. The devious person would need to remove data from the CA's database to substitute a bogus item.

Examples of other data that can be stored in NV-Storage for increased authentication include a device specific private key, a device specific symmetrical encryption key, random data known only by the AA. This Other Data will be used during cryptographic functions and never read out of the chip directly. An example of the use of this Other Data 840 being used in authentication challenge is shown in FIG. 9.

In FIG. 9 Step 1 AA issues a challenge data request to the collectable item 100 via a Trusted Reader 500. Collectable Item 100 receives challenge data in Step 2-a. In Step 2-b collectable item uses Other Data 840 as one input to cryptographic function 910 and the challenge request data as the other input to cryptographic function 910, and generated the output results of the cryptographic function as Output Results 920. Output Results 920 can be sent back to AA. Optionally, Output Results 920 can be encrypted using Public Key of AA and sent back to AA.

In FIG. 9 Step 3, AA receives Output Results 920 from cryptographic function 910 and AA verifies Output Results 920 using same computation or determining expected results on AA computer.

Not shown in FIG. 9, an optional step to have the Collectable Item 100 authenticate the AA server used in the challenge request by using standard client/server authentication methods used for computer cryptography.

FIG. 10 shows an abbreviated diagram of how the Output Results 920 is generated. Other input values can be used for the challenge authentication verification such as signed hashes, random numbers, etc. Authentication Unique Data 800 is applied as one of the inputs during challenge requests from an AA.

In FIG. 10 variable A input to cryptographic function 910 can be challenge data 905 from M shown in FIG. 9 Step 1. Or, variable 10 can be other data obtained locally from within the chip or from AA. In FIG. 10 variable B input to cryptographic function B can be any one of the Authentication Unique Data Values shown in FIG. 8. FIG. 10 variable B input preferred values are items 820 Signed Message Digest, 830 Private Key, and 840 Other Data. Other data values can be substituted as inputs to Cryptographic Function 910 in FIG. 10 obtained locally from within the Unique ID hardware or from the AA.

Referring back to FIG. 2, the NV-Storage can also be programmed to store collector specific data such as their own keys, their identification (name, address, fingerprint, etc.) in the NV-Storage.

Chip optionally uses cryptographic techniques to verify that only the AA can store data within Non-Volatile Storage such as video clips, text, or images about the collectable item. When a write to Non-Volatile Storage is requested by a store or trusted reader, the chip can verify information provided by AA before storing data to memory.

When collector data (not Authentication Unique Data 800) is written to NV-Storage 210 a command will be issued to Controller 230 via RF/Coil Interface 240 or equivalent. Controller 230 can require and validate additional data to verify AA issued programming command. This optional verification step will be required extra data to authenticate that the AA issued the programming command when the write command is issued, such as a digitally signed value that can be verified using Authentication Unique Additional write command data such as Signed Message Digest 820, Private Key 830, or Other Data 840 will be used to verify that the AA is issuing the write command. Programming command additional data can be verified by decrypting programming command or additional data using the Public Key of AA stored in Authentication Unique Data 800 area of Unique ID chip. Program command additional data validation will be performed by Controller 230 using a computation as shown in FIG. 10 and validate the Output Results 920 before storing video, text, or audio information in NV-Storage 210. If the Output Results 920 of computation 910 is valid programming will proceed, otherwise programming will not proceed and an optional failed programming attempt variable will be incremented.

The data retention time of the NV-Storage 210 in this invention is extended beyond that normally guaranteed by the chip manufacturers. For example, many RFID chips quote a data retention life of 5 to 10 years. For a collectable 5 years to 10 years is not long enough and the NV-Storage 210 contents must be periodically refreshed. Refresh periods of less than the data retention life of the NV-Storage in RF chip will be with a Data Retention Refresh operation performed in one of many different modes. Authentication Authority (or other entity) will track when periodic refresh of the RFID is necessary and will send notification to the items registered owner before expiration period of NV-Storage contents.

A preferred embodiment of the current system stores the Unique ID in permanent memory that does not need period refreshing.

The Data Retention Refresh cycle will be performed using the minimum amount of activity to properly refresh the NV-Storage 210 array. Minimum amount of activity to properly refresh memory will depend on the memory technology used in RFID. EEPROM memory will require different refresh operation than ferroelectric memory which will be different than flash memory. Controller 230 will perform reading and/or reprogramming NV-Storage 210 array to refresh NV-Storage such that data retention time is extended.

AA database or even the chip itself can identify the date and time of the last refresh (or program operation) and use the date and time of last refresh to determine when the refresh needs to reoccur. Any type of reader can cause a Data Retention Refresh. Data Retention Refresh can be performed by Controller 230 without exposing the Authentication Unique Data 800 within the chip outside of the chip. Hacker methods to determine the value of the chips Authentication Unique Data 800 such as monitoring the chip emissions or the power being used by the RFID can be thwarted by using industry known techniques to disguise emissions and current consumption during the Data Retention Refresh Cycle activity and the authentication read activities.

AA can notify a collector when a Data Retention Refresh Cycle is required by using any type of communication means such as telephone calls, emails, faxes, postal mail, notices in newspapers, radio adds, or on television. Data Retention Refresh Cycle can be performed automatically when chip is read based on time stamp or notification from AA.

Readers can read the date and time of the last Data Retention Refresh Cycle and notify collector via telephone, email, voice mail, or on the display of PC or reader that a refresh cycle should be performed. Controller 230 can read data and time from reader and perform Data Retention Refresh cycle.

Data Retention Refresh Cycle can be secured to eliminate the potential that the NV-Storage gets refreshed too many times causing the memory cells to wear out. Data Retention Cycle command can be secured in the same manner as the way collector data writes is authenticated (described above).

If Authentication Unique ID 800 data is stored in program storage that has a permanent storage life and is not based on a stored charge as in EEPROM or the magnetic flux of a cell (Ferro Electric Memory Cells) data retention refresh is not required.

Active Readers

Collectable item 100 can use an active RFID for Unique ID 100 or a passive RFID for Unique ID 100. One embodiment of this invention includes a passive RFID and an active RFID to allow both local (passive) Unique ID reading where battery life for accessing the Unique ID does not limit the time a Unique ID can be read. A second active RFID in the same object with the passive RFID allows the Unique ID to be read from a farther distance than a passive ID. The passive ID can provide 100's of years of access life without the need for a battery, while the active ID can track the collectable ID as it moves around a stadium and the batteries may provide years of service life. After the active IDs batteries die, the passive ID will allow collects to access the Unique ID.

An example multiple RFID readers within a stadium is the use of two RFID reads mounted to, or near the goalpost uprights wherein the RFID reader is used to detect whether ball crosses plane of goalpost.

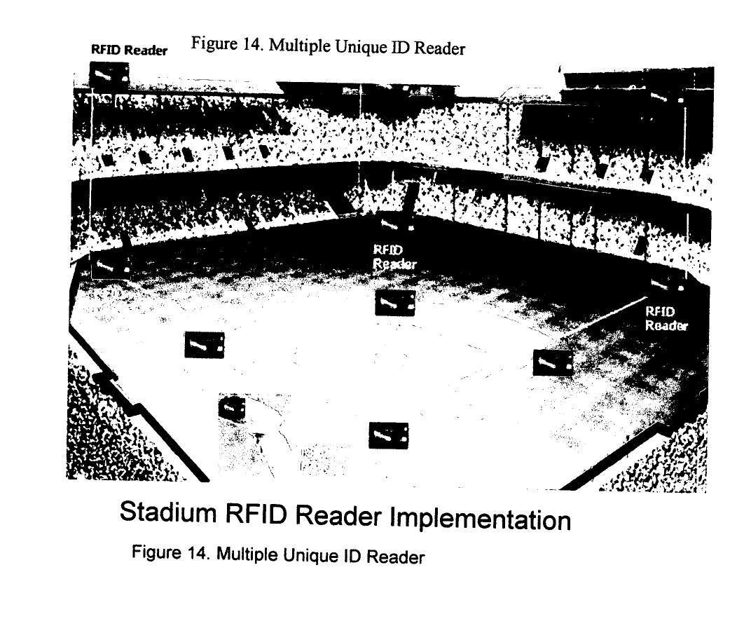

FIG. 14 depicts a baseball stadium showing the location of multiple RFID readers positioned throughout a stadium. In FIG. 14 the RFID near home plate represents a single RFID reader worn by the umpire, or multiple RFID readers worn by the umpire, and optionally another RFID reader worn by the catcher. As described in FIG. 3 an umpire can wear multiple RFID readers. Data collected by any or all of the RFID readers can be selectively incorporated into the collectable items database. For example, when a historic hit is made on the third pitch of a ball, data for all of the pitches made with the historic ball can be recorded into the database or only the time of the actual hit itself. Multiple RFID readers can be network (not shown) using standard networking techniques. When multiple RFID readers are network, each RFID reader can be authenticated using the authentication methods described by this invention or other standard network element authentication techniques.

Active ID readers within a stadium can read the active ID chips radio signal at a distance of up to 100 or more feet. This means ballpark sensors can detect the path of a ball in motion and with triangulation on the signal trajectory and location information can be derived from the active ID signal strength. ID readers (Active or Passive) can also be in retail stores for authenticating consumer purchases and automatically registering consumer purchases as described in other sections of this invention.

When an active or passive ID is included in a collectable device the active ID can be in sleep mode and switched to active mode from sleep mode from the passive RFID after the passive RFID is scanned, or from an impact sensor or motion sensor detecting motion, or from an active RFID wakeup signal that turns on the active RFID signal. Devices with active RFID and passive RFID can have identical or different serial number and Unique IDs.

A single passive RFID can be used along with a battery powered RF transmitter signal booster to extend the range of the passive RFID. Passive RFID will work even after the battery in the RF transmitter device dies. The RF of the passive RFID will work in parallel with the RF transmitter that can be at the same frequency or a different frequencies then passive RFID transmit frequency.

Passive RFID can send wakeup signal to active RFID to extend battery life of active RFID. Passive RFID when detecting a scan can activate the active RFID and active RFID stays active for a predetermined period of time, or for a period of time after motion stops. Or, active reader can detect motion or impact and activate active RF reader so stadium mounted readers can detect the balls trajectory after being hit.

System Usage Example:

A key element of this invention is the automatic tracking of collectable items such as a baseball, uniform, golf ball, or other piece of sports memorabilia. The elements of the automatic tracking process are shown in FIG. 3. Depicted in FIG. 3 is a baseball umpire 320 outfitted with a RFID wrist reader 310, a pouch 330 to hold baseballs (before they become collectable items).

During play, umpire 320 will grab a baseball 100 from pouch 330, and throw the baseball 100 into play. When the umpire 320 grabs a ball 100 and removes the ball from the pouch 330, RFID wrist reader 310 worn on the umpires 320 arm will record the Unique ID 110 code contained in ball 100. RFID reader 310 can store data internal to RFID wrist reader 310, or transmit the Unique ID to a local inventory tracking system (not shown). Regardless of where the Unique ID data is stored and which system element adds the timestamp of when the ball 100 was placed into game play, the umpire using a normal action of normal game play, for example, placing a ball into service, will automatically record the Unique ID of the ball 100.

Ball storage pouch 330 can also include a RFID reader 311 to keep track of the balls remaining in the pouch at periodic time intervals, allow the ID of balls to be determined in the event that RFID wrist reader 310 malfunctions. Pouch RFID reader 311 will record the Unique IDs of all the balls in pouch 330 and the date and time at periodic intervals. Pouch reader 311 can be an optional element in the system. Similar RFID readers can be installed for example in the pitchers and catchers mitts of the players. Because the date and time are added by RFID readers, the accuracy of the tracking of historic events increases.

Data collected by RFID wrist reader 310, RFID pouch reader 311, and/or other RFID readers worn by players or installed at strategic locations in the stadium will be sent to a local system data logger or stored within the reader for transfer to a system data logger at a later date. Collected data from the RFID(s) will be entered into the database for the collectable item 100. During game play at a stadium, a warning is issued to the umpire when an RFID reader used to capture Unique IDs during game play did not record the Unique ID 110 properly. Motion detectors in wrist reader can detect when a umpire uses a throwing motion without the wrist reader detecting the balls Unique ID and the wrist reader can alert the umpire of the failure to read Unique ID.

Even when the wrist reader 310 fails to read the Unique ID 100 the balls Unique ID 100 can be determined based on the balls 100 in the ball pouch 330, pouch reader 311 and date and time of pouch reader 311 inventory capture. Pouch reader 311 inventory capture can occur on a period basis or when the umpire adds/or removes balls to pouch. Pouch reader can include a switch to indicate access into and out of the pouch to trigger when to take ball inventory.

RFID Wrist Reader:

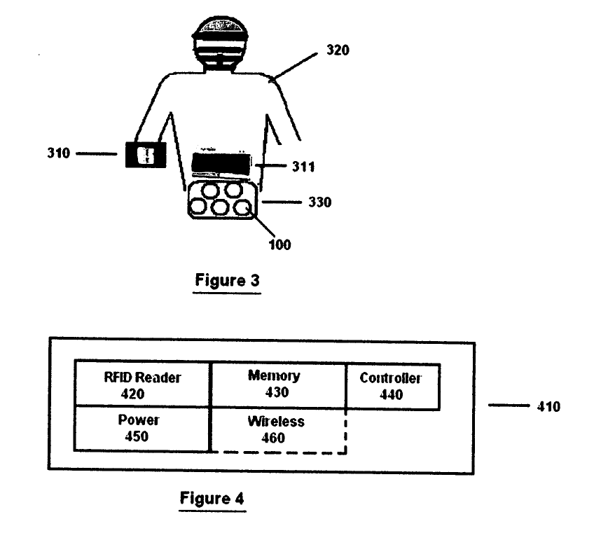

The examples of an RFID wrist reader 310 is shown in FIG. 4. Referring to FIG. 4 there is an RFID wrist reader 410 that generates the RF signal necessary to read the Unique ID 110 from collectable item 100, in this example a baseball. RFID wrist reader includes a power source 450, optional memory 430, a controller 440 that coordinates the operation of the RFID wrist reader. RFID wrist reader 410 also includes an optional wireless communications link 460 providing communications to a remote data collection system element (not shown). Optional wireless communications link 460 can be used to transmit Unique ID information with or without timestamp information for database recording by a remote data collection system. The example shown in FIG. 4 is a wrist band mounted RFID reader, and numerous other mounting methods can be used for RFID readers that track Ids and date and time information for historic events. Examples of other mounting methods include adding to the ball pouch 330 in FIG. 3 and adding to the gloves of players (not shown).

Wrist reader 310 can also include an alarm or alert signal to umpire that the Unique ID 110 in an item 100 has not been properly read or detected. Alert will indicate to umpire that RFID was not properly read.

Authentication Of Items:

One of several different authentication methods can be used to authenticate items depending on the application. A collector can use casual authentication when they want to read a Unique ID from an item for their own enjoyment, such as sharing information with a friend. A purchaser at a reputable store will have a system that has a higher level of authentication with the Authentication Authority allowing the purchaser to feel confident that the store article is authentic. Store level authentication can occur using reader hardware stored in an interesting storefront package such as a miniature bank vault design package or some other creative looking design. The key requirement for authentication at the store or resale level is that the collector can feel confident that the item is being properly authenticated with the Authentication Authorities database.

Collectors can register with the Authentication Authorities database such that when a collector requests authentication while in a store, a voice message is sent directly from AA to the telephone number registered by the consumer on the Authentication Authorities database. This provides the consumer another level of authentication the Authentication Authority can use when authenticating an item. Authentication Authority will make a voice call to the consumers registered telephone number in AA database, or send an email message to an address or phone number in the AA database and not known by the store clerk.

A unique code can be added to the consumers' registration with the Authentication Authority database that is only known by the Authentication Authority and is reported (voiced, emailed, text messaged) back to the consumer to validate authentication. Authentication Authority can play video or audio of the event that made the item valuable on a display at a store or on the telephone or computer of the collector.

AA can also use forensics techniques and data to guarantee the authenticity of a collectable item. Forensic data will be stored in AA database with the Unique ID and forensic data such as X-Ray scans of collectable devices, scans of the RFID and how it was installed in the collectable (such as a piece of rare china), exact position of storage (angle of chip, angle of antenna, 3 dimensional coordinates of location of chip or antenna, etc.) Added forensic data allows AA to use position, angle of chip rotation and other salient features to authenticate real and fraudulent items in the event the authenticity of a high value articles is being challenged.

All of the readers described in this invention will support reading Unique IDs using methods commensurate or appropriate for the type of Unique ID chip used to identify collectable item. For example, if the Unique ID is stored using an RFID chip that requires a 2.4 GHz RFID reader then the Authentication Authority database will contain an entry as to what type of reader is required for the collectable item. A different collectable item may use a Unique ID that requires a 300 MHz RFID reader, or uses an ID chip or part that does not even use RF energy. In such a case the term reader as described and used in the description of this invention includes the appropriate reader technology to read or extract the Unique ID information from the collectable item.

Collector Registration:

Collectors 605 can register their name and contact information (physical address, telephone number, email address, cellular telephone number, etc.) with the Authentication Authority 670 allowing the Authentication Authority 670 to contact the collector when authenticating an item at a trade show. Information known only to the collector 605 can also be securely stored in the Authentication Authority database 680 and this collector specific information can be used by the Authentication Authority 670 to identify the Authentication Authority 670 to the collector. A unique alpha or numeric code, a word or word phrase, or message can be entered when collector 605 registers with the Authentication Authority 670. And, this unique message or phrase can be played back to collector 605 by CA 670 during the interactive authentication of an item.

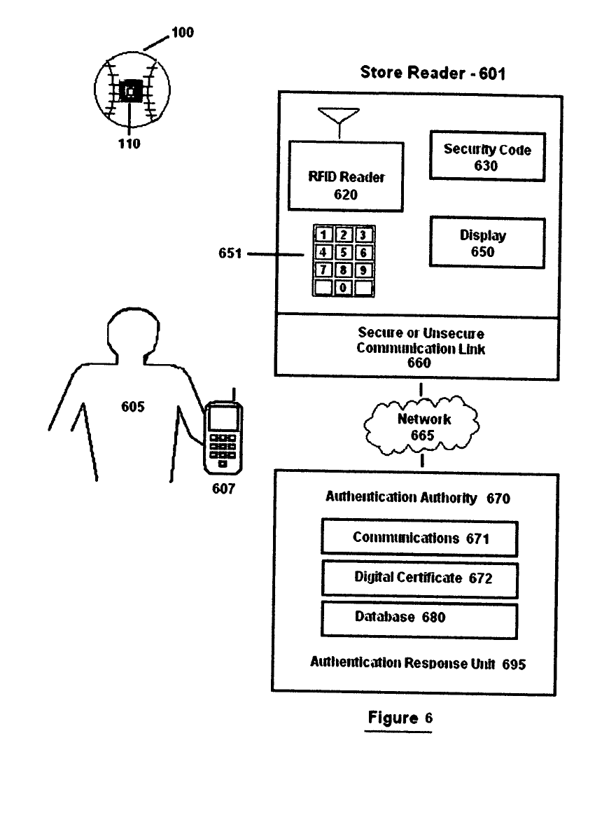

The collector 605 when purchasing or seeking information on a collectable item 100 can request interactive authentication of an item. An overview of the interactive authentication process is provided below. Realize that this is only an overview of the process and various steps can be changed while still maintaining the uniqueness of the interactive authentication aspect of this invention.
Interactive Authentication Process (Refer to FIG. 6):
   1) Item 100 is scanned using reader 601 for Unique ID 110 embedded within item.
   2) Reader 601 contains a communications link 660 with Authentication Authority 670 communication link 671.
   3) When communications occurs via network 665 between Store Reader 601 and Authentication Authority 670 security code 630 of Store Reader 601 can be validated by Authentication Authority 670 using CA Database 680 to validate Store Reader 601. Security codes can be based on X.509 digital certificates, smart cards, security dongles or other secure hardware/software methods.
   4) The Store Reader 601 can validation that Authentication Authority 670 is correct by using the CA's Digital Certificate 672 information. CA's Digital Certificate 672 information can be displayed to collector 605 using Display 650 on Store Reader 601. Digital Certificate 672 can be validated using and standard Digital Certificate validation service such as Verisign.
   5) Once the Store Reader 601 and Authentication Authority 670 are validated over network 665 the Store Reader 601 will transmit the Unique ID information stored on the storage device 110 in the collectable item 100.
   6) Store Reader 601 will send Unique ID Information from storage device 110 to Authentication Authority 670.
   7) Authentication Authority 670 will use the Unique ID code 110 information to identify collectable item 100.
   8) An optional step allows the Authentication Authority 670 to send an authentication challenge to collectable item 100 via network 665 and Store Reader 601. This option step uses the Unique ID information 110 in collectable item 100 and the optional crypto hardware 220 shown in FIG. 2. Crypto hardware 220 FIG. 2 will be explained in other parts of this application.
   9) After verifying the optional authentication challenge in the above step, Authentication Authority will display the authentication results to customer 605 via display 650.
   10) Additionally, Authentication Authority can notify customer 605 via a message from CA's Authentication Response Unit 695. Customer notification message can be sent to customer 605 email address, or an automated text or voice message can be sent via a telephone call from Authentication Response Unit 695 to customer 605 mobile or cellular telephone 607. Authentication Response Unit 695 text or voice message shall indicate the results of the authentication of an item that the customer 605 is interested in. Authentication Response Unit 695 can voice a message such as “the baseball with unique ID 54522156788 is home run number 899 ball hit by Al Yokenstien on Aug. 14, 2003 at 7:53 PM at San Diego Stadium.” Authentication Response Unit 695 can respond with a message such as “the baseball with unique ID 54522156788 does not appear to be authentic” for collectable items that may have been compromised. A key element to Authentication Response Unit 695 is that it will use information that is not available to the store owner, eliminating the potential that the store owner can create bogus authentication responses. The information that is not available to the store owner was created by the customer 605 using a customer (or collector) registration means to register customer 605 specific information with Authentication Authority 670.
   11) Optional storage contained in collectable item 100 can include storage of video or audio footage of the event that marked the uniqueness of the collectable item 100. This optional storage allows collector 605 to view the historic event on Display 605 of Store reader 601.
   12) If collectable item 100 does not store video or audio footage of the historic event, Authentication Authority 670 can send event audio or video to display 650 on Store Reader 601. AA 670 can also send event audio, video, or text information to any personal computer via the internet or network (not shown).
   13) After a historic event, the video or audio footage can be added to collectable item 100. A similar authentication will occur as to that described above. Storage of video or audio footage will not allow the Unique ID information to be modified. The collector 605 who has possession of the collectable item 100 can identify themselves only to the Authentication Authority 670 allowing the Authentication Authority 670 to register the collector 605 with the CA's Data Base 680. Subsequent attempts to register the same collectable item 100 with the same Unique ID 110 will allow CA 670 to determine that a collectable item 100 has been copied and CA 670 can begin procedures to authenticate the original item and alert authorities to the fraud attempt.

Store Reader 601 can include optional keypad 651 to allow collector to add a unique number during the authentication process at the store site to make sure that store clerk does not substitute a different item during authentication. The unique number will be sent or voiced back to the collector 605 using Authentication Authority 670 Authentication Response Unit 695. This unique number is not related to the Unique ID 110 stored in collectable item 100. Rather it is a convenience for the collector 605 to know that the item 100 being authenticated using Store Reader 601 is the item scanned by RFID Reader 620 of the Store Reader 601, and not another item substituted by the store clerk.

RFID can be read as customer leave store similar to the way security tags work, but the sale and item are logged out and upon exit the Unique ID is verified as the customer leaves the store. Unique ID will also eliminate employee theft because a thief will not be able to register the collectable with an M.

Trusted Authenticators (Trusted Readers)

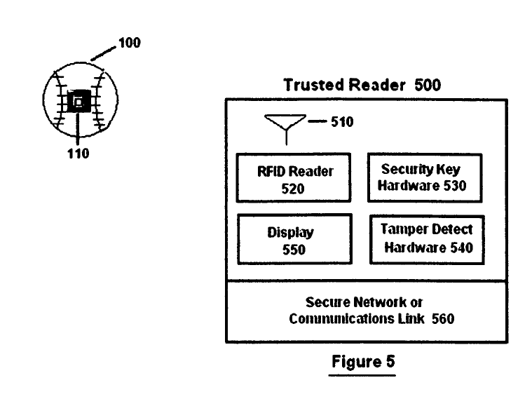

The Trusted Reader 500 (FIG. 5) is a hardware device that is guaranteed to be a secure reading device issued by the Authentication Authority for the collectable item. Only the Trusted Reader 500 should be used to validate high value collectables. Trusted Reader 500 can also be used to authenticate consumer items at retail stores and can be housed in a store cash register, credit card reader, bar code reader wand, or standalone unit.

Trusted reader has secure link 560 to Authentication Authority central authentication computer and the Trusted Reader 500 has unique identification in the form of Trusted Reader 500 unique information 530 in the form of security key hardware, embedded encryption keys and/or hardware smart card that allows Trusted Reader 500 to securely identify itself and communication with Authentication Authority. For absolute proof that an item is authentic a Trusted Reader 500 must be used and the Trusted Reader 500 must be at a well know secure location with a secure communications link to the Authentication Authority. Without the Trusted Reader being at a secured and monitored location such as a secure portion of a arena, bank, ball park, etcetera, validity of Trusted Reader information can be compromised by dishonest collectors. Trusted Reader 500 contains Tamper Detect Hardware 540 that will identify when Trusted Reader 500 has been tampered with. Trusted Reader 500 can contain a plurality of tamper detection hardware and/or software 540 to detect and report to Authentication Authority when a Trusted Reader 500 has been tampered with.

Based on Trusted Reader or Store level security reader a broker service can be established whereby owners can sell collectables to buyers. Broker can be at Trusted AA level such that buyers can be assured of authenticity. When broker is at store level, customer can be assured item is authentic by verifying the Unique ID when receiving the item from a broker and customer will register the transaction such that they become the registered owner. If broker does not have database registration entry at AA site for the item than a buyer can identify this broker as not being legitimate.

Store And Consumer Readers

The hardware cost and security requirements of the Trusted Reader 500 preclude the installation of Trusted Readers 500 at most collectable stores and at individual collectors homes. Two different types of less expensive readers called a Consumer Reader and Store Reader will allow identification and casual authentication of lower value items without the guaranteed authentication provided by the Trusted Reader.

Consumer Readers do not guarantee the collectable item as being authentic, meaning that they are not as secure as the Trusted Reader. Consumer Readers in the hands of dishonest people can compromise the value of the reader, allowing the dishonest person to identify non-authentic items as authentic. The purpose of the Consumer reader is to allow the casual reading of data stored in collectable items. Consumer readers can also be attached to home computers allowing individuals to read the items ID and other data for their own enjoyment. FIG. 6 Store Reader 601 shows the high level components of a Store Reader 601. A consumer reader (not shown) is similar in functionality to Store Reader 601 but does not need the Display 650, Keypad 651, Security Code 630 and Secure Communications Link 660. In fact, a simple version of the Consumer Reader can simply read the Unique Information 110 stored in collectable 100. Consumer Reader will read Unique Information 110 via a RFID reader when RFIDs are used to store the Unique ID 110.

Consumer reader can be attached to a personal computer. Link between RFID on consumer reader and AA database for accessing information about the item can be performed over the Internet or using other suitable communications method. Information from collectable item 100 can be read by PC with consumer reader and displayed on PC. PC with attached consumer reader can access AA database and provide AA Unique ID for the item being scanned and programming running on PC can retrieve collectable items information from AA.

Other Readers:

Other readers with characteristics commensurate with the application can be derived from the elements contained within the Consumer, Store, and Trusted readers described above. An example would be a group of readers installed at various locations within a baseball park.

History Tracking:

In addition to the Unique ID 110 and date and time information recorded for each collectable item 100, the Authentication Authority, or league organization sanctioning the event can add detailed historic documentation in the form of text, new paper articles, audio, and visual information to the Authentication Authorities database. Added detailed historic documentation represents the “official” or authentic description of the event including details store in text, audio, and/or visual format. Detailed historic documentation can also be stored within collectable item 100 in NV-Storage 210 (FIG. 2).

Chain of sales transactional history on the sale/resale of collectable items can be tracked by the Authentication Authority and stored in Authentication Authorities database and within the collectable item 100 itself using NV-Storage 210 (FIG. 2). Retailers and resellers of collectables can read the collectable Unique ID and record the Unique ID on the sales receipt of the collectable item. The name and other information about the purchaser can be stored in the NV-Storage 210 (FIG. 2) within the collectable, or on the AA database. Tracking of sales history will eliminate fraudulent items. When housed in a fireproof enclosure, RFID can help eliminate insurance fraud by being detectable after a fire or damage to a collectable item. Insurance company can scan the fire damage and read the Unique ID from a damaged or destroyed collectable item to verify that the item was lost in the fire. Insurance company can notify AA to record fire damage claim in AA database, thus eliminating the value of the lost collectable item.

A callback voicemail, email, or other message from the Authentication Authority to the collector can be placed to verify the validity of a high value item. Caller ID and/or voice prompt can be used to identify the telephone number of the Authentication Authority when the Authentication Authority is calling to verify the authenticity of a high value item.

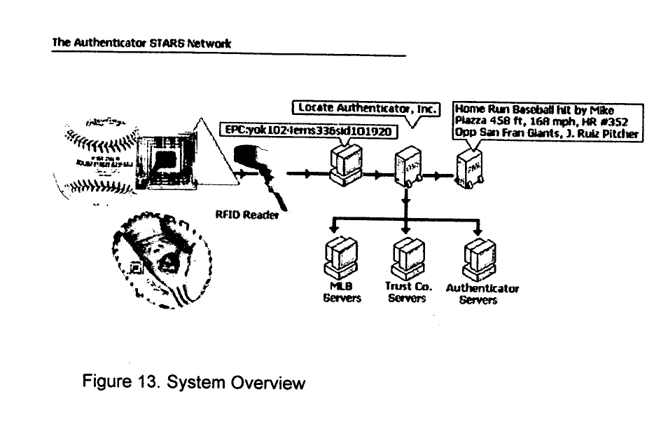

FIG. 13 provides a system overview of the collectable authentication system described in this application.

Authentication of Authentication Authority. The validity of an authentication must be validated and this is achieved via a signed message response validated by a well known trusted certificate authority such as Verisign, Major League Baseball, trading card companies, credit card companies or other trusted institutions. Trusted Reader includes security hardware to uniquely identify Trusted Reader and tamper detection hardware to invalidate security hardware in the event the Trusted Reader is tampered with.

A Smart Pen (not shown) or scanner can be used to capture baseball players signature to be added to database or storage inside collectable item. Using a Smart Pen where the signature can be detected by the motion of the pen, player can sign the ball and the motion of the signature movement can be store in AA database or within the collectable item being signed. Smart Pen will record motion of players signature when signing a collectable and store the motion in a format that represents the players signature in the AA database or the collectable item itself.

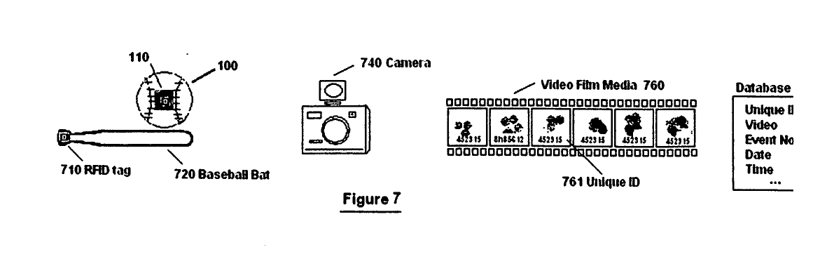

FIG. 7 shows linking of the Unique ID 110 of collectable item 100 in play to live broadcast video being transmitted to television viewer of the event and on the local TV screen at the ballpark. When umpire places a ball 100 in play the Unique ID can be broadcast in one of many different ways to the TV video recording equipment used to record the event and broadcast the event on television or live over the Internet. The Unique ID 110 can be displayed on a visible area of the TV signal by TV video camera 740 or by other video broadcast processing equipment (not shown). Unique ID 100 can be added in a visible or non-visible area of video signal such as Vertical Blanking Interval line-21 data or in other areas of the visible or non-visible areas of the video signal. FIG. 760 shows four frames of video from the camera 740 and the frames of video information can have Unique ID and other information described above added to video frame data. Video camera 740 can include receiver to receive the Unique ID value of the ball in play. Broadcast booth can receive Unique ID value of ball in play to allow Unique ID value to be added to game statistics displayed on TV screens and in newspaper articles and scoreboards. Audio signals can also be used to transmit the Unique ID information. Collectors watching a game can identify the Unique ID 110 of the collectable item 100 they wish to acquire and register their interest in the item with the Authentication Authority. Database information for teams, games, players, etc. can contain full history of every ball used in the game. Games that seem rather insignificant can contain highly valued collectables such as a great pitchers final strike out ball, or a hall of fame hitters last hit. Non-home run balls can now become collectable because the balls history is indexed with the action of the game on an inning by inning, ball by ball basis.

Database entries shown as 790 in FIG. 7 depicts the Unique ID value be stored in database with video, audio, date, and time stamp data of historic event. Video can be single data frames or video sequences with or without Unique ID information stored in video signal 761.

Database Examples

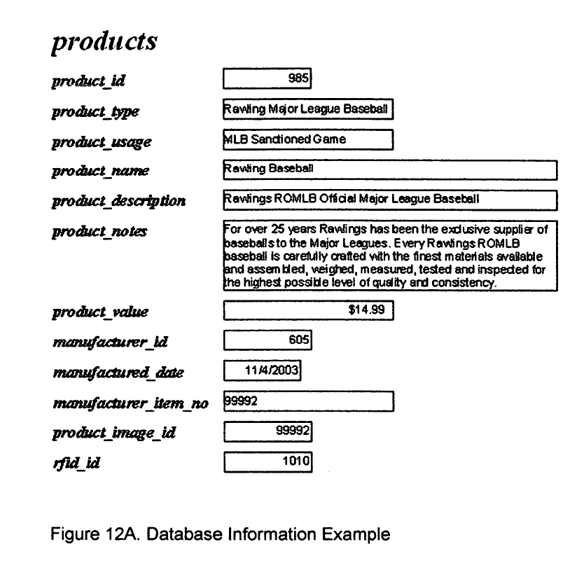

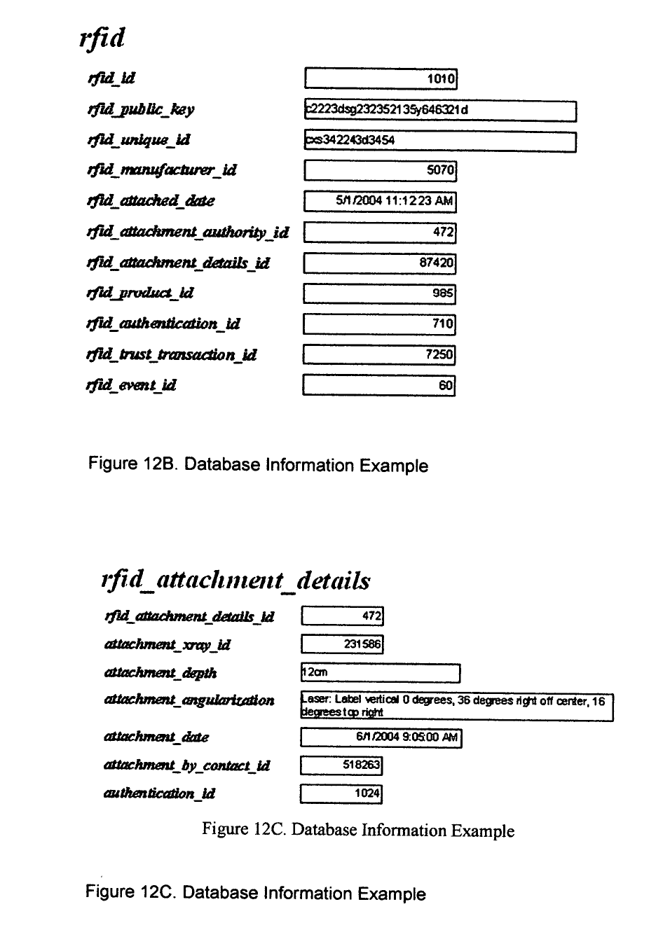

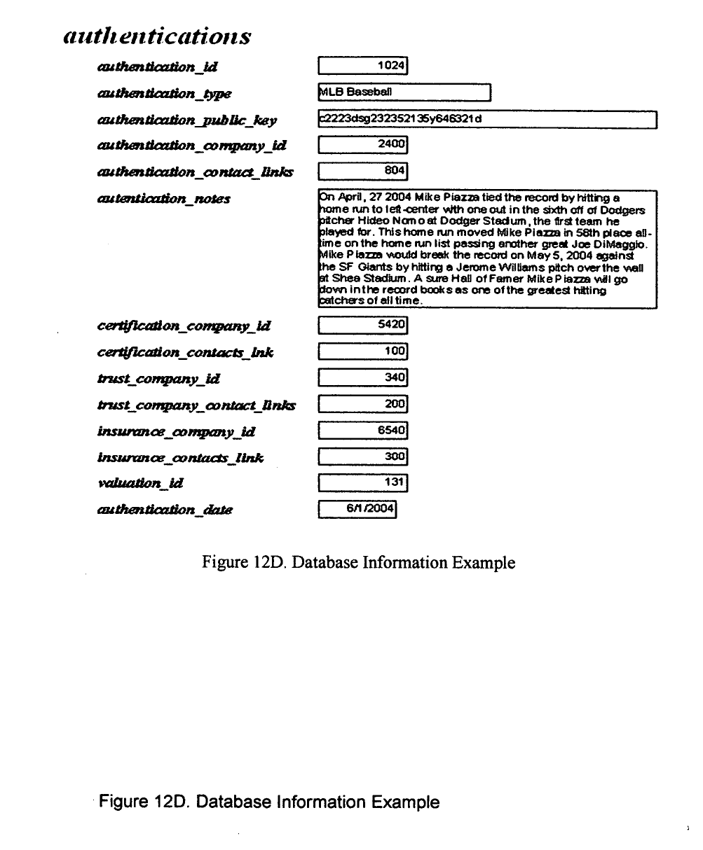

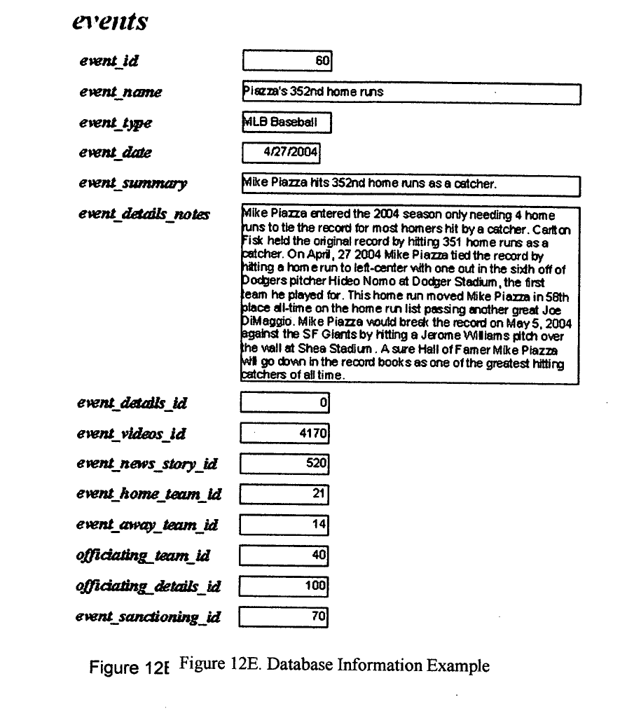

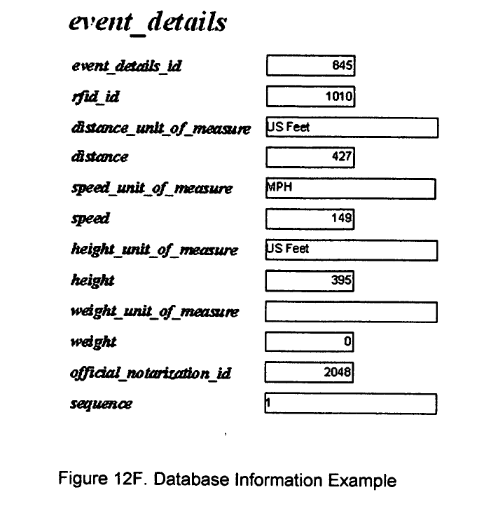

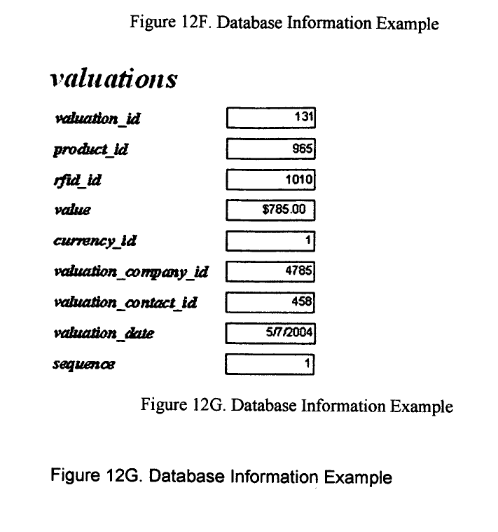

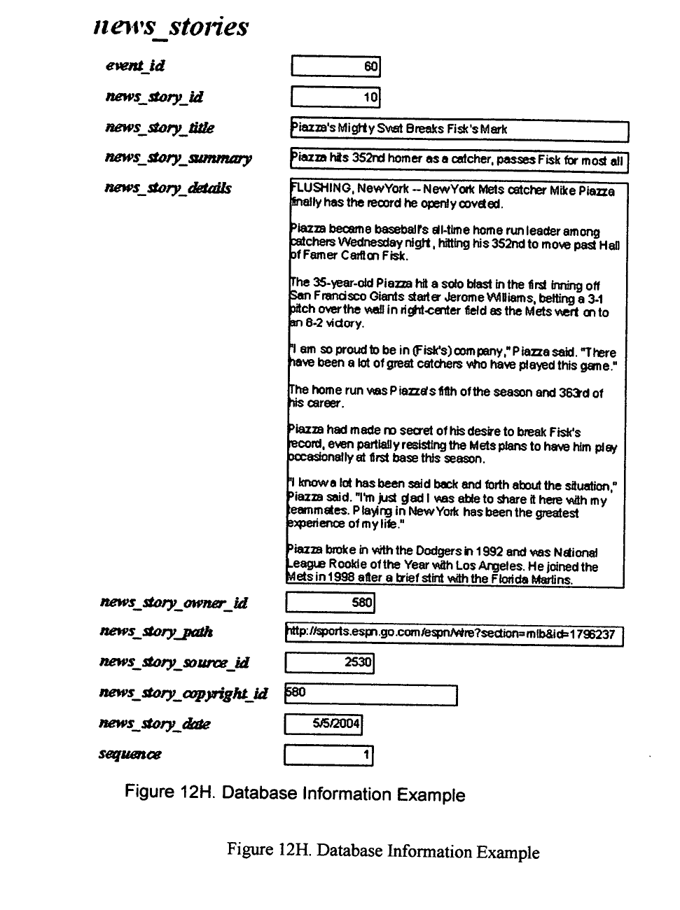

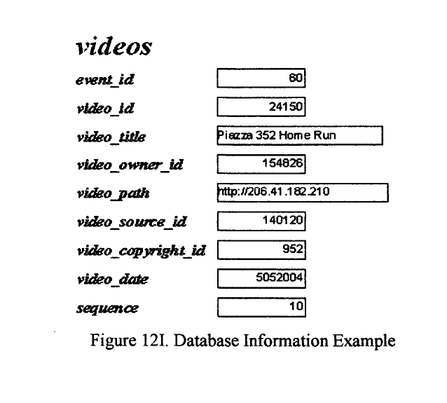

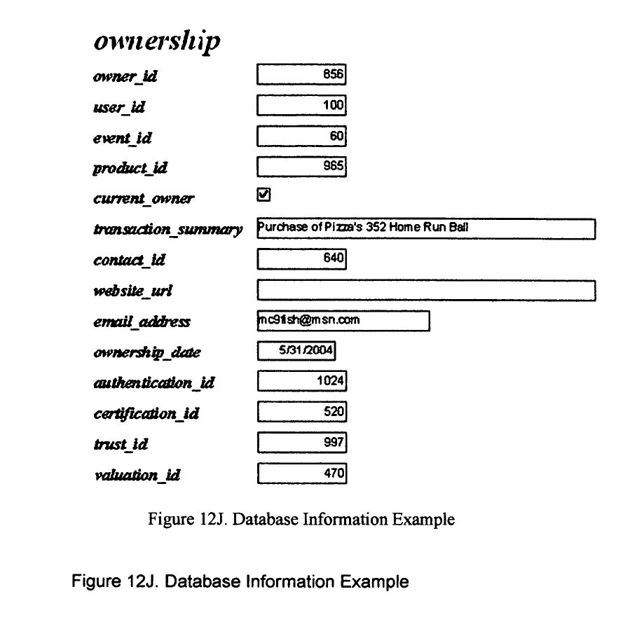

FIGS. 12A through 12J show the various data values that can be stored within a collectable item. The invention described within this application should not be limited by any or all of the data values shown in the examples in FIGS. 12A through 12J. Rather, FIGS. 12A and 12J show example data that can be applied to a baseball collectable item. The database for other types of collectables may be different than that shown in FIGS. 12A through 12J without limiting the scope of this invention. Even when applied to baseball the data values shown in FIGS. 12A through 12J may be different without impacting the scope of the invention. Likewise, the storage of any or all of the example data values shown in FIGS. 12A through 12J can be stored within the collectable item itself, or the Authentication Authority database, a combination of both, or a combination of both and other databases (collectable item, Authentiation Authority, manufacturer database, Major League Baseball database, team database, etc.) Use of single or multiple storage locations for database and the distribution of data across databases also should not limit the scope of the invention.

FIG. 12A shows an example data contained within an RFID incorporated within a baseball. Pertinent information regarding the baseball itself can be stored in the Non-Volatile memory storage within the baseball itself or stored in the Authentication Authority database.

FIG. 12B shows an example of the RFID data values. It is important to note that as little as a RFID value shown in the RFID_ID field can be used to identify an object. Other data values increase the authentication strength of a collectable item.

FIG. 12C shows an example of a database items containing details related to how the RFID was physically attached to a collectable item. This attachment information can remain private to the Authentication Authority and can be used to authenticate disputed items. For example, if the authenticity of a baseball, or a piece of art is in question, data contained in this database record, such as the attachment angle can be used to physically verify that the RFID is in the proper placement location as scanned by the manufacturer after manufacturing.

FIG. 12D shows example data about the authentication of a collectable item. The authentication type for this example shows MLB Baseball (for Major League Baseball), other authentication types for art, clothing, etc. can be stored in this database example.

FIG. 12E provides data examples for the event itself that made the item valuable.

FIG. 12F provides more event details as well as an ID of the agent or agency that notarized the event data.

FIG. 12G shows collectable item valuation information.

FIG. 12H provides newspaper, magazine, internet text data, or other news data related to the event that made the collectable item valuable.

FIG. 12I provides television, internet video, or other video data related to the event that made the collectable item valuable. Video data can be stored within the collectable item itself, by Authentication Authority or at one or more video archive databases.

FIG. 12J provides information about the owner of the collectable item to substantiate the ownership lineage of the collectable item.

1. Establishment of an object's unique id comprised of public key & private key encryption pairings
Storage for date and time item placed into game
Storage for date and time item was either created, distributed, placed into service, or purchased
Storage for historic images or video of an event or object authentication of an item
Registering existing collectables with ownership lineage being established such that even if another item has the unique ID, or the unique ID is stolen or removed from a device the ownership lineage will be used to identify the items compromised background.
Recording of the exact position an RFID tag is embedded within or onto an object
Permanent adhesion of an RFID tag on to an object
Tamper proof RFID tag application
Creation of the object's “life-cycle”, such manufacturing, distribution, sales, ownership, and valuation details as records within a database
Access to the object's “life-cycle” data by successful authentication and validation challenges
Identification of fraudulent or counterfeit items
Registration of ownership rights to an object by using a product's encrypted key
Utilization of a trusted authority to perform irrefutable authentication services
Utilization of a trusted reader to perform validated reading/interrogation of an RFID tag
Establishment of a cohesive network of computers and servers to accomplish an encrypted key's creation, the encrypted key writing into an RFID tag, the RFID tags placement into or onto an object, and the tracking of that object's logistical data.
The exact position of an RFID tag into or onto an object utilizing XRay, MRI, CatScan, or some other means to internally record the physical placement of the RFID tag
